(19) United States
(12) Patent Application Publication
(10) Pub. No.: US 2026/0156400 A1
(43) Pub. Date: Jun. 4, 2026

(54) AUDIO DEVICE COMPRISING MICRO VALVE

(71) Applicant: Samsung Electronics Co., Ltd., Suwon-si (KR)

(72) Inventors: Myungcheol LEE, Suwon-si (KR); Hunki LEE, Suwon-si (KR); Jungyeol AN, Suwon-si (KR); Byeongmin LEE, Suwon-si (KR); Byounghee LEE, Suwon-si (KR); Yonghoon LEE, Suwon-si (KR); Jeock LEE, Suwon-si (KR); Joonrae CHO, Suwon-si (KR)

(21) Appl. No.: 19/463,755

(22) Filed: Jan. 29, 2026

Related U.S. Application Data
(63) Continuation of application No. PCT/KR2024/010354, filed on Jul. 18, 2024.

(30) Foreign Application Priority Data
Sep. 18, 2023 (KR) 10-2023-0124322
Oct. 18, 2023 (KR) 10-2023-0139923

(51) Int. Cl. H04R 1/10; H04R 29/00

(52) U.S. Cl. CPC H04R 1/1041; H04R 1/1016; H04R 1/1075; H04R 29/001; H04R 2460/11

(57) ABSTRACT

An earpiece is provided. The earpiece includes a housing, a speaker including a diaphragm and disposed within the housing, wherein the housing includes a front space of the diaphragm, an acoustic port connected to the front space to transmit acoustic by the speaker to an outside of the earpiece, and a vent hole connected to the front space, a valve configured to open or at least partially close the vent hole, a sensor disposed within the housing, and a processor configured to determine, using the sensor, a leakage level of the acoustic port, and based on the determined leakage level, control a degree of closure of the valve such that the leakage level of the acoustic port is reduced.

### CROSS-REFERENCE TO RELATED APPLICATION(S)

This application is a continuation application, claiming priority under 35 U.S.C. § 365(c), of an International application No. PCT/KR2024/010354, filed on Jul. 18, 2024, which is based on and claims the benefit of a Korean patent application number 10-2023-0124322, filed on Sep. 18, 2023, in the Ministry of Intellectual Property, and of a Korean patent application number 10-2023-0139923, filed on Oct. 18, 2023, in the Ministry of Intellectual Property, the disclosure of each of which is incorporated by reference herein in its entirety

### BACKGROUND

### 1. Field

The disclosure relates to an audio device including a micro valve.

### 2. Description of Related Art

A personal audio device such as earphones and earbuds may provide various audio content such as music, an audio book, and a call by being inserted into or around a user's ear. An audio device, which was initially connected to a host device by wire, is being converted to wireless communication, particularly a connection using Bluetooth. In addition, various functions such as noise canceling and an ambient sound mode are being added to improve a user experience.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an audio device including a micro valve.

Additional aspects will be set forth in part in the description which follows and, in part, will be apparent from the description, or may be learned by practice of the presented embodiments.

In accordance with an aspect of the disclosure, an earpiece is provided. The earpiece includes a housing, a speaker including a diaphragm and disposed within the housing, wherein the housing includes a front space of the diaphragm, an acoustic port connected to the front space to transmit acoustic by the speaker to an outside of the earpiece, and a vent hole connected to the front space, a valve configured to open or at least partially close the vent hole, a sensor disposed within the housing, and a processor configured to determine, using the sensor, a leakage level of the acoustic port, and based on the determined leakage level, control a degree of closure of the valve such that the leakage level of the acoustic port is reduced.

In accordance with another aspect of the disclosure, an earpiece that does not include an ear tip is provided. The earpiece includes a housing, a speaker including a diaphragm and disposed within the housing, wherein the housing includes a front space of the diaphragm, an acoustic port connected to the front space to transmit acoustic by the speaker to outside of the earpiece, and a vent hole connected to the front space, a valve configured to open or at least partially close the vent hole, a sensor disposed within the housing, and a processor configured to determine, using the sensor, a leakage level of the acoustic port, and based on the determined leakage level, control a degree of closure of the valve such that the leakage level of the acoustic port increases.

In accordance with another aspect of the disclosure, an earphone configured to be worn on a user's ear is provided. The earphone includes a housing forming an outer surface of the earphone that is in contact with the user's ear, a driver including a diaphragm, wherein the housing includes a first space, a second space separated from the first space by the diaphragm, an acoustic port connected to the first space to transmit acoustic generated by the driver to an outside, a first vent hole formed on the outer surface and connected to the first space, a second vent hole formed on the outer surface and connected to the second space, and a third vent hole located inside the housing and connecting the first space and the second space, a first valve configured to regulate air flow in the first vent hole, a second valve configured to regulate air flow in the second vent hole, a microphone located within the first space, and a processor configured to output acoustic through the driver, detect acoustic pressure in the first space using the microphone while the acoustic is outputted, based on the acoustic pressure, determine a leakage level of the acoustic port, and based on the determined leakage level, control a degree of closure of the first valve and a degree of closure of the second valve, such that the leakage level of the acoustic port is reduced.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram indicating an electronic device according to an embodiment of the disclosure;

FIG. 2 is a diagram indicating an electronic device according to an embodiment of the disclosure;

FIG. 3 is a diagram indicating an electronic device according to an embodiment of the disclosure;

FIG. 4 is a diagram indicating an electronic device according to an embodiment of the disclosure;

FIG. 5 is a diagram indicating an electronic device according to an embodiment of the disclosure;

FIG. 6 is a diagram indicating an electronic device according to an embodiment of the disclosure;

FIG. 7 is a diagram indicating an electronic device according to an embodiment of the disclosure;

FIG. 8 is a diagram indicating an electronic device according to an embodiment of the disclosure;

FIG. 9 is a diagram indicating an electronic device according to an embodiment of the disclosure; and

FIG. 10 is a block diagram of an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

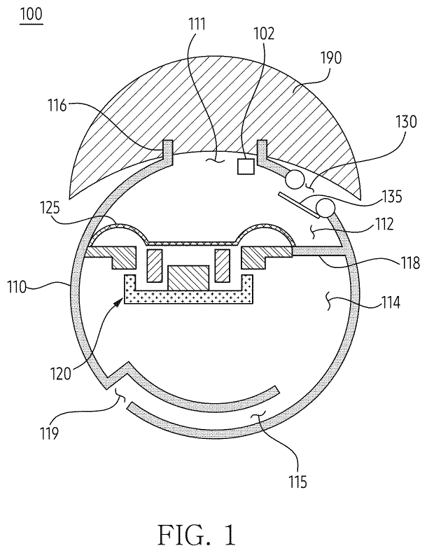

FIG. 1 is a diagram indicating an electronic device according to an embodiment of the disclosure.

Referring to FIG. 1, an electronic device 100 according to an embodiment may provide acoustic by being worn on a user's ear. The electronic device 100 may be referred to as an earpiece, earbuds, an earphone, a headphone, or a personal audio device. The electronic device 100 according to an embodiment may include a housing 110, a speaker 120, a first valve 135, a sensor 102, and an ear tip 190.

In an embodiment, the housing 110 may form an exterior of the electronic device 100. The housing 110 may be in contact with the user's ear. In an embodiment, the housing 110 may include an acoustic port 111, a front space 112, a rear space 114, a first vent hole 130, an external port 119, and a first conduit 115.

In an embodiment, the speaker 120 configured to output acoustic may be disposed inside the housing 110. The speaker 120 may include a diaphragm 125 that generates a sound wave by vibration. A sound wave may be formed in the front space 112 and the rear space 114 of the diaphragm 125 by the vibration of the diaphragm 125 In an embodiment, the front space 112 and the rear space 114 may be divided by the diaphragm 125. As a non-limiting example, the front space 112 and the rear space 114 may be divided by the diaphragm 125 and a partition wall 118 of the housing 110. As a non-limiting example, the speaker 120 may include a dynamic speaker. In an embodiment, the speaker 120 may be referred to as a driver.

In an embodiment, the acoustic port 111 may be formed at an end 116 of the housing 110. The acoustic port 111 may be connected to the front space 112. The acoustic by the speaker 120 may be transmitted to an outside (e.g., the user's ear) through the front space 112 and the acoustic port 111.

In an embodiment, the first vent hole 130 may be formed on an outer surface of the housing 110 to be connected to the front space 112. The first vent hole 130 may connect the front space 112 to the outside. In an embodiment, the first valve 135 may be provided in the first vent hole 130. For example, the first valve 135 may be configured to open or at least partially close the first vent hole 130.

In an embodiment, the external port 119 may be formed on the outer surface of the housing 110 to be connected to the rear space 114. For example, the external port 119 may be connected to the rear space 114 through the first conduit 115 formed inside the housing 110. The rear space 114 may be connected to the outside of the electronic device 100 through the first conduit 115 and the external port 119.

In an embodiment, the sensor 102 may be disposed in the housing 110. The sensor 102 may include, for example, at least one of a wear detection sensor, a biometric sensor, a gyro sensor, a geomagnetic sensor, a GPS sensor, a body temperature detection sensor, a moisture detection sensor, a barometric sensor, a Hall sensor, a proximity sensor, a capacitive sensor, a pressure sensor, an acoustic sensor (e.g., a microphone), and/or a touch sensor.

In an embodiment, the ear tip 190 may be coupled to the housing 110. For example, the ear tip 190 may be coupled to the end 116 of the housing 110 to surround the acoustic port 111. The ear tip 190 may reduce leakage of acoustic outputted to the acoustic port 111 by being in contact with the user's ear wearing the electronic device 100.

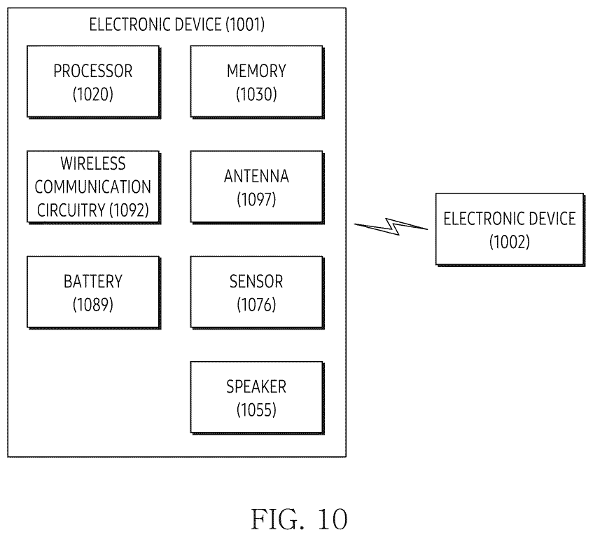

Although not illustrated, the electronic device 100 according to an embodiment may include a processor (e.g., a processor 1020 of FIG. 10). The processor may control the first valve 135 such that an operation of the electronic device 100, for example, a flow rate of the first vent hole 130 is regulated.

Since a shape of the user's ear wearing the electronic device 100 varies, a degree of sealing between the acoustic port 111, the ear tip 190, and an ear canal of the user may be different according to the user. In a case that leakage of the acoustic port 111 occurs, performance (e.g., low frequency performance) of a speaker system of the electronic device 100 may be deteriorated.

The electronic device 100 according to an embodiment may adjust a leakage level of the speaker system of the electronic device 100 by varying air flow in the first vent hole 130 through the first valve 135. Through this, deterioration of acoustic performance due to leakage of the acoustic port 111 may be compensated.

For example, the processor may determine a leakage level of the acoustic port 111 using the sensor 102. As a non-limiting example, the sensor 102 may include a microphone disposed within the front space 112 and configured to receive acoustic. The processor may determine the leakage level of the acoustic port 111 based on acoustic pressure of a designated frequency band (e.g., a low frequency band) received by the microphone while the speaker 120 outputs acoustic. For example, as the leakage level of the acoustic port 111 increases, an acoustic pressure level received by the microphone may decrease. As a non-limiting example, the sensor 102 may be configured to detect acoustic impedance of the front space 112. A resonant frequency of the front space 112 may be changed according to a degree of leakage of the acoustic port 111, and accordingly, the acoustic impedance of the front space 112 may be changed. The processor may determine a leakage level of the acoustic port 111 by detecting the change in the acoustic impedance.

In an embodiment, the processor may control a degree of closure of the first valve 135 based on the determined leakage level such that the leakage level of the acoustic port 111 is reduced. For example, the processor may control the first valve 135 such that, as a leakage level of the acoustic port 111 increases, a degree of closure of the first valve 135 increases. As a non-limiting example, the degree of closure of the first valve 135 may be controlled according to a predetermined table including an amount of control according to the leakage level, and/or may be feedback-controlled such that the determined leakage level through the sensor 102 matches a predetermined leakage level

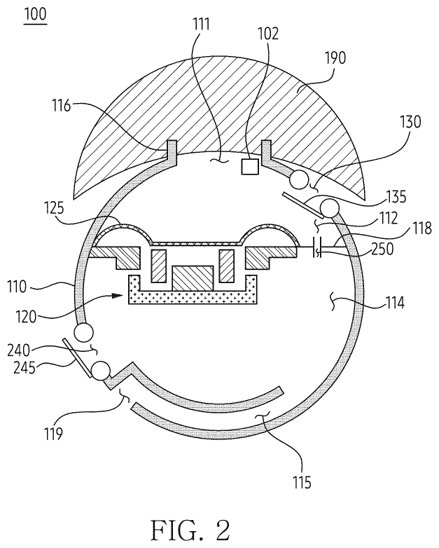

FIG. 2 is a diagram indicating an electronic device according to an embodiment of the disclosure.

Referring to FIG. 2, a housing 110 according to an embodiment may include a second vent hole 240 and a third vent hole 250. In an embodiment, the second vent hole 240 may be formed on an outer surface of the housing 110 such that a rear space 114 of a diaphragm 125 is connected to an outside. In an embodiment, the third vent hole 250 may be formed in a partition wall 118 of the housing 110 such that a front space 112 is connected to the rear space 114.

In an embodiment, a first vent hole 130, the second vent hole 240, and the third vent hole 250 may remove fatigue due to pressure applied to an eardrum of a user by adjusting a balance between a pressure in an ear canal of the user wearing the electronic device 100 and an external pressure.

In an embodiment, a first conduit 115 connected to the first vent hole 130, the second vent hole 240, the third vent hole 250, and an external port 119 may adjust performance of the speaker 120 such as multimedia output, noise cancellation, and ambient sound listening.

The electronic device 100 according to an embodiment may include a second valve 245 provided to the second vent hole 240. In an embodiment, the second valve 245 may be configured to open or at least partially close the second vent hole 240 The second valve 245 may be controlled by the processor. Flow of air through the second vent hole 240 may be regulated according to opening and closing of the second valve 245.

Alternatively or optionally, unlike the illustration, a first valve 135 may be disposed in the third vent hole 250 and configured to control air flow in the third vent hole 250. In this case, optionally, the second valve 245 may be omitted.

The electronic device 100 according to an embodiment may adjust a leakage level of a speaker system of the electronic device 100 by varying air flow in the first vent hole 130 and the second vent hole 240 through the first valve 135 and the second valve 245. Through this, deterioration of acoustic performance due to leakage of the acoustic port 111 may be compensated.

For example, the processor may control a degree of closure of the first valve 135 and/or the second valve 245 based on the determined leakage level such that a leakage level of the acoustic port 111 is reduced.

As a non-limiting example, in a case that the leakage level of the acoustic port 111 is equal to or greater than a first threshold, the processor may close (e.g., fully close) the first valve 135 and the second valve 245. As a non-limiting example, in a case that the leakage level of the acoustic port 111 is less than the first threshold and equal to or greater than a second threshold, the processor may close (e.g., fully close) the first valve 135 and open (e.g., fully open) the second valve 245. The second threshold may be smaller than the first threshold. As a non-limiting example, in a case that the leakage level of the acoustic port 111 is less than the second threshold and equal to or greater than a third threshold, the processor may open (e.g., fully open) the first valve 135 and close (e.g., fully close) the second valve 245. The third threshold may be smaller than the second threshold. As a non-limiting example, in a case that the leakage level of the acoustic port 111 is less than the third threshold, the processor may open (e.g., fully open) the first valve 135 and the second valve 245. Herein, an example in which the first valve 135 and/or the second valve 245 are fully opened or fully closed has been described, but is not limited thereto. For example, according to the leakage level of the acoustic port 111, the first valve 135 and/or the second valve 245 may be opened or closed in stages.

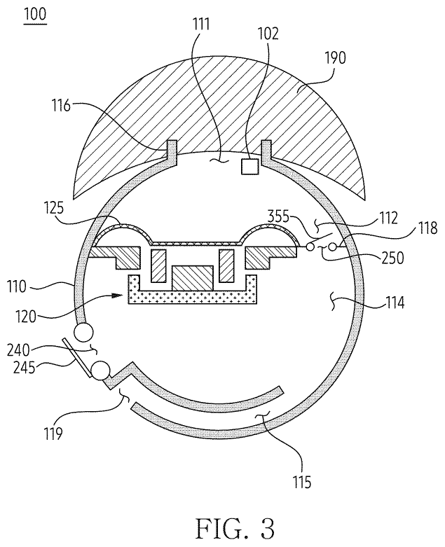

In addition, although not illustrated, the electronic device 100 according to an embodiment may include a third valve (e.g., a third valve 355 of FIG. 3) configured to open or close the third vent hole 250. The valves 135, 245, and 355 of the electronic device 100 may be referred to as micro valves. As a non-limiting example, for an actuation mechanism of the valves 135, 245, and 355, a piezoelectric actuation structure, an electrostatic actuation structure, an electromagnetic actuation structure, a thermoelectric actuation structure, or an actuation structure using a polymer conductive polymer that shrinks and expands by an applied voltage may be used.

FIG. 3 is a diagram indicating an electronic device according to an embodiment of the disclosure.

Referring to FIG. 3, unlike FIG. 2, an electronic device 100 according to an embodiment may not include a first vent hole 130 and a first valve 135.

The electronic device 100 according to an embodiment may include a third valve 355 provided to a third vent hole 250. In an embodiment, the third valve 355 may be configured to open or at least partially close the third vent hole 250. The third valve 355 may be controlled by a processor. Flow of air through the third vent hole 250 may be regulated according to opening and closing of the third valve 355.

The electronic device 100 according to an embodiment may adjust a leakage level of the speaker system of the electronic device 100 by varying air flow in a second vent hole 240 and the third vent hole 250 through a second valve 245 and the third valve 355. Through this, deterioration of acoustic performance due to leakage of an acoustic port 111 may be compensated. For example, the processor may control a degree of closure of the second valve 245 and/or the third valve 355 based on the determined leakage level such that a leakage level of the acoustic port 111 is reduced.

Referring to FIGS. 1, 2, and 3, it has been described that at least one degree of closure of the first valve 135, the second valve 245, and/or the third valve 355 is controlled such that the leakage level of the speaker system of the electronic device 100 is reduced, but is not limited thereto. For example, the valves of the vent holes may also be controlled to increase the leakage level of the speaker system according to characteristics required according to a function provided by the electronic device 100 or a user's setting.

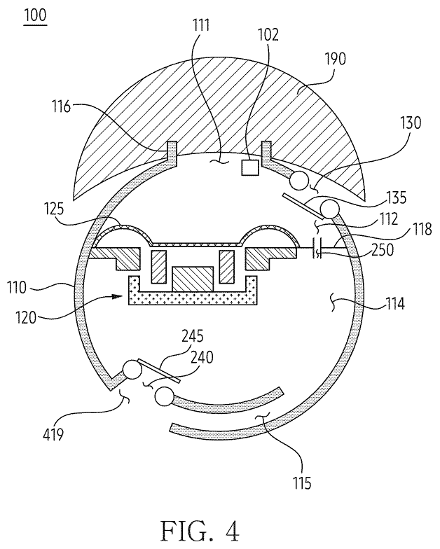

FIG. 4 is a diagram indicating an electronic device according to an embodiment of the disclosure.

Referring to FIG. 4, a housing 110 according to an embodiment may include an external port 419 (e.g., the external port 119 of FIG. 1). The external port 419 may be formed on an outer surface of the housing 110 to be connected to an outside of the electronic device 100.

In an embodiment, a second vent hole 240 may be connected to the outside of the electronic device 100 by being connected to the external port 419. In an embodiment, a first conduit 115 may be connected to the outside of the electronic device 100 by being connected to the external port 419. For example, the second vent hole 240 may be connected to a portion of the external port 419, and the first conduit 115 may be connected to another portion (or a remaining portion) of the external port 419. In an embodiment, the second vent hole 240 may be aligned with the external port 419 (e.g., the portion of the external port 419). Through this, the number of holes visible from an outside of the housing 110 may be reduced.

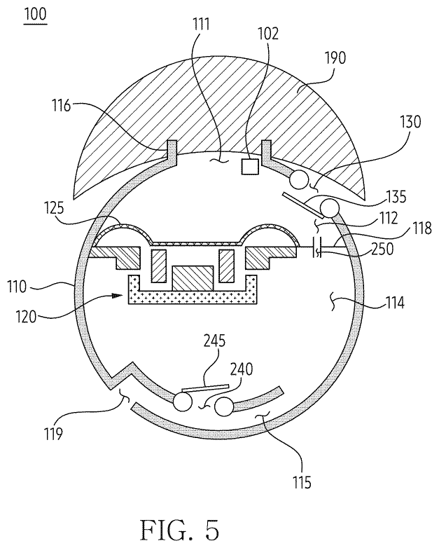

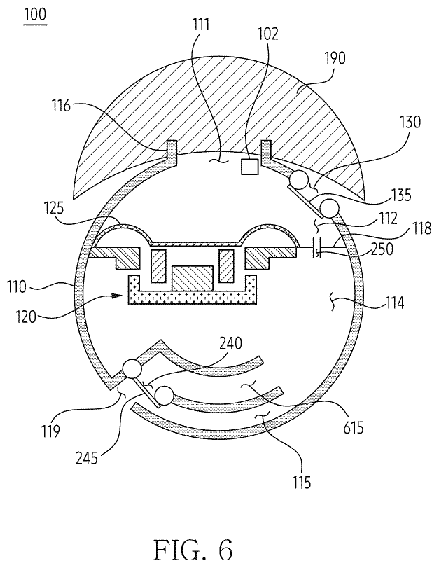

FIGS. 5 and 6 are diagrams indicating an electronic device according to various embodiments of the disclosure. In an embodiment, a housing 110 may include a conduit structure having various lengths and/or areas to adjust a ventilation amount and leakage sound of an inner space.

For example, referring to FIG. 5, a second vent hole 240 may be formed in a first conduit 115. For example, the second vent hole 240 may be directly connected to the first conduit 115 and may be connected to an outside through the first conduit 115 and an external port 119.

For example, referring to FIG. 6, the housing 110 of the electronic device 100 according to an embodiment may further include a second conduit 615. In an embodiment, the second conduit 615 may extend from the second vent hole 240 to a rear space 114. The second vent hole 240 may be connected to the rear space 114 through the second conduit 615. In an embodiment, the second conduit 615 may extend parallel to the first conduit 115, but is not limited thereto.

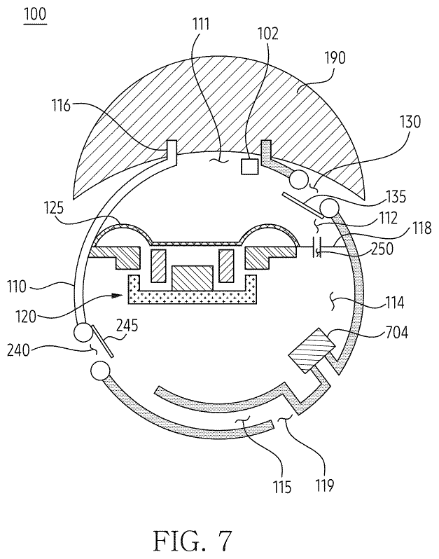

FIG. 7 is a diagram indicating an electronic device according to an embodiment of the disclosure.

Referring to FIG. 7, an electronic device 100 according to an embodiment may include a microphone 704 disposed in a housing 110. In an embodiment, the microphone 704 may be configured to receive an external acoustic of the electronic device 100. As a non-limiting example, the electronic device 100 may provide a noise canceling function and/or an ambient sound listening function based on an external sound through the microphone 704. As a non-limiting example, the microphone 704 may include a feedforward microphone of an active noise canceling system.

In an embodiment, an external port 119 may be located between a second vent hole 240 and the microphone 704. The external port 119 may be located closer to the microphone 704 than the second vent hole 240. A first conduit 115 may extend from the external port 119 so as to be away from the microphone 704. For example, the first conduit 115 may extend from the external port 119 toward the second vent hole 240. Through this, it may prevent a problem (e.g., howling by the microphone 704) that may occur in a case that a second valve 245 is opened.

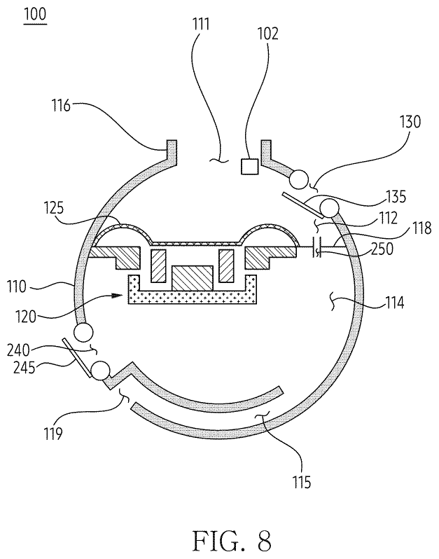

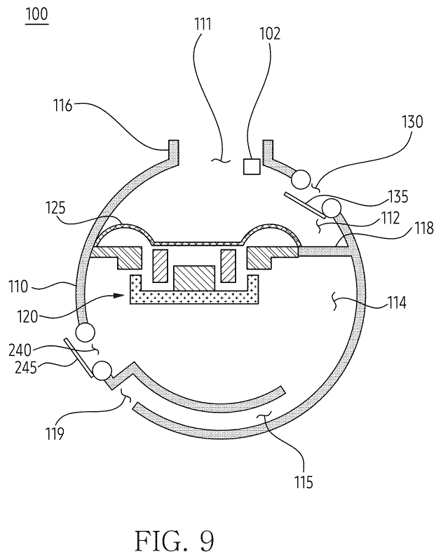

FIGS. 8 and 9 are diagrams indicating an electronic device according to various embodiments of the disclosure.

Referring to FIGS. 8 and 9, an electronic device 100 according to an embodiment may not include an ear tip (e.g., the ear tip 190 of FIG. 7). As a non-limiting example, the electronic device 100 may be an open-type earphone used without the ear tip. As a non-limiting example, the electronic device 100 may be an audio device that may be used as a kernel-type earphone or an open-type earphone according to whether the ear tip is coupled.

As a non-limiting example, in a case that the ear tip is coupled, as a first vent hole 130 is closed, an influence due to leakage of an acoustic port 111 may be reduced. On the other hand, in a case that the ear tip is separated, as the first vent hole 130 is opened, an influence due to leakage of the acoustic port 111 may be reduced. As a non-limiting example, an external port 119 may compensate for deterioration in low-band performance due to leakage of acoustic. In an embodiment, the processor may determine whether the ear tip is coupled. For example, the processor may determine whether the ear tip is coupled, by using a signal (or data) obtained using a sensor 102 (e.g., a Hall sensor, a proximity sensor, or a capacitive sensor). In an embodiment, the processor may control opening and closing of valves 135, 245, and 355 according to whether the ear tip is coupled and/or a leakage level of a speaker system determined using the sensor 102. For example, in a case that the ear tip is coupled, the description provided with reference to FIGS. 1 to 7 may be applied substantially the same to an operation of the processor. For example, in a case that the ear tip is not coupled, the processor may control the valves 135, 245, and 355 differently from the case that the ear tip is coupled. For example, in the case that the ear tip is not coupled, the processor may control a degree of closure of at least one of the valves 135, 245, and 355 based on the determined leakage level such that the leakage level of the acoustic port 111 increases. For example, the processor may control such that, as the leakage level of the acoustic port 111 decreases, a degree of closure of at least one of the valves 135, 245, and 355 decreases.

Through this, it may optimize acoustic performance according to whether the ear tip is coupled.

Referring to FIG. 9, the housing 110 of the electronic device 100 according to an embodiment may not include a vent hole (e.g., the third vent hole 250 of FIG. 8) for connecting a front space 112 and a rear space 114.

Additionally, the electronic device 100 according to an embodiment may further include another vent hole (not illustrated) connecting the front space 112 to an outside. In a case that the electronic device 100 does not include the ear tip, the other vent hole may improve acoustic characteristics of a speaker 120.

FIG. 10 is a block diagram of an electronic device according to an embodiment of the disclosure.

Referring to FIG. 10, an electronic device 1001 (e.g., the electronic device 100 of FIG. 9) according to an embodiment may include a processor 1020, memory 1030, wireless communication circuitry 1092, a sensor 1076 (e.g., the sensor 102 of FIG. 1), a speaker 1055 (e.g., the speaker 120 of FIG. 1), and a battery 1089. In an embodiment, the processor 1020 may include processing circuitry or control circuitry, such as a micro controller unit (MCU), a central processing unit (CPU), a sensor processor, a sensor hub, an application processor (AP), and/or a communication processor (CP).

In an embodiment, the processor 1020 may control an operation of the electronic device 1001. In an embodiment, the operation controlled by the processor 1020 may be at least partially performed by a processor of an external device (an electronic device 1002) paired to the electronic device 1001.

In an embodiment, the speaker 1055 may output an acoustic signal (or an audio signal) received from the external electronic device 1002 (e.g., a terminal of a user).

In an embodiment, the battery 1089 may supply power to a component of the electronic device 1001. The battery 1089 may include a rechargeable secondary battery or a fuel cell.

In an embodiment, the wireless communication circuitry 1092 may establish a wireless communication channel with the electronic device 1002, and perform communication using the established communication channel. In an embodiment, the wireless communication circuitry 1092 may transmit various data (e.g., audio data) through the antenna 1097 to the external electronic device 1002 connected (e.g., paired) through a designated network (e.g., a short-range communication network) or receive it from the external electronic device 1002.

In an embodiment, the antenna 1097 may transmit a signal (e.g., data or power) to the external electronic device 1002 or may receive a signal from the external electronic device 1002. As a non-limiting example, the antenna 1097 may include one or more antennas including a conductor formed on a substrate (e.g., a printed circuit board (PCB)) or a radiator formed of a conductive pattern.

In an embodiment, the memory 1030 may store various data used by at least one component (e.g., the processor 1020 or the sensor module 1076) of the electronic device 1001. The data may include, for example, software and input data or output data for a command related thereto. In an embodiment, the memory 1030 may include a volatile memory and/or a nonvolatile memory.

In an embodiment, the memory 1030 may store one or more programs (or an application) and instructions executed by the processor 1020 and/or the processor of the external electronic device 1002. In an embodiment, the memory 1030 may temporarily and/or provisionally store data inputted to/outputted from the electronic device 1001 and/or the external electronic device 1002.

An earpiece (e.g., the electronic device 100 of FIG. 1) according to an embodiment may include a housing (e.g., the housing 110 of FIG. 1), a speaker (e.g., the speaker 120 of FIG. 1), a valve (e.g., the valve 135 of FIG. 1), a sensor (e.g., the sensor 102 of FIG. 1), and a processor (e.g., the processor 1020 of FIG. 10). The speaker may include a diaphragm (e.g., the diaphragm 125 of FIG. 1) and be disposed within the housing. The housing may include a front space (e.g., the front space 112 of FIG. 1) of the diaphragm, an acoustic port (e.g., the acoustic port 111 of FIG. 1) connected to the front space to transmit acoustic by the speaker to an outside of the earpiece, and a vent hole (e.g., the first vent hole 130 of FIG. 1 or the third vent hole 250 of FIG. 3) connected to the front space. The valve may be configured to open or at least partially close the vent hole. The sensor may be disposed within the housing. The processor may be configured to determine, using the sensor, a leakage level of the acoustic port. The processor may be configured to, based on the determined leakage level, control a degree of closure of the valve such that the leakage level of the acoustic port is reduced. Through this, it may reduce an influence due to leakage of the acoustic port, which may vary according to a user.

In an embodiment, the sensor may include a microphone disposed within the front space of the housing.

In an embodiment, the sensor may be configured to detect acoustic impedance of the front space.

In an embodiment, the vent hole may connect the front space to the outside. In an embodiment, the vent hole may be a first vent hole (e.g., the first vent hole 130 of FIG. 1) connecting the front space to the outside. In an embodiment, the housing may include a rear space (e.g., the rear space 114 of FIG. 1) of the diaphragm, a second vent hole (e.g., the second vent hole 240 of FIG. 1) connecting the rear space to the outside, and a third vent hole (e.g., the third vent hole 250 of FIG. 2) connecting the rear space to the front space. In an embodiment, the valve may be a first valve (e.g., the first valve 135 of FIG. 1). In an embodiment, the earpiece may include a second valve (e.g., the second valve 245 of FIG. 2) configured to open or at least partially close the second vent hole. The processor may be configured to control a degree of closure of the first valve and the second valve based on the determined leakage level, such that the leakage level of the acoustic port is reduced.

In an embodiment, the processor may be configured to close the first valve and the second valve in response to determining that the leakage level of the acoustic port is equal to or greater than a first threshold.

In an embodiment, the processor may be configured to, in response to determining that the leakage level of the acoustic port is less than the first threshold and equal to or greater than a second threshold, close the first valve and open the second valve. The second threshold may be smaller than the first threshold.

In an embodiment, the processor may be configured to, in response to determining that the leakage level of the acoustic port is less than the second threshold and equal to or greater than a third threshold, open the first valve and close the second valve. The third threshold may be smaller than the second threshold.

In an embodiment, the processor may be configured to, in response to determining that the leakage level of the acoustic port is less than the third threshold, open the first valve and the second valve.

In an embodiment, the housing may include a hole (e.g., the external port 419 of FIG. 4) formed on an outer surface of the housing, and a conduit (e.g., the first conduit 115 of FIG. 4) connecting the rear space to the outside. In an embodiment, the second vent hole and the conduit may be connected to the outside through the hole.

In an embodiment, the housing may include a hole (e.g., the external port 119 of FIG. 5) formed on an outer surface of the housing, and a conduit (e.g., the first conduit 115 of FIG. 5) extending from the hole to the rear space. In an embodiment, the second vent hole may be formed in the conduit.

In an embodiment, the second vent hole may be aligned with the hole.

In an embodiment, the housing may include another conduit (e.g., the second conduit 615 of FIG. 6) extending from the second vent hole to the rear space.

In an embodiment, the earpiece may include another microphone (e.g., the microphone 704 of FIG. 7) disposed within the rear space. The housing may include a hole (e.g., the external port 119 of FIG. 7) formed on an outer surface of the housing, and a conduit (e.g., the first conduit 115 of FIG. 7) extending from the hole to the rear space In an embodiment, the second vent hole may be formed on the outer surface of the housing and located farther from the other microphone than the hole.

The earpiece according to an embodiment may include a third valve (e.g., the third valve 355 of FIG. 3) configured to open or at least partially close the third vent hole. The processor may be configured to control the degree of closure of the first valve, the second valve, and the third valve based on the determined leakage level, such that the leakage level of the acoustic port is reduced.

In an embodiment, the vent hole may be a first vent hole (e.g., the first vent hole 130 of FIG. 2) connecting the front space to the outside. In an embodiment, the housing may include a rear space (e.g., the second rear space 114 of FIG. 2) of the diaphragm, a second vent hole (e.g., the second vent hole 240 of FIG. 2) connecting the rear space to the outside, and a third vent hole (e.g., the third vent hole 250 of FIG. 2) connecting the rear space to the front space. The valve may be a first valve (e.g., the first valve 135 of FIG. 2). The earpiece may include a second valve (e.g., the third valve 355 of FIG. 3) configured to open or at least partially close the third vent hole. The processor may be configured to control a degree of closure of the first valve and the second valve based on the determined leakage level, such that the leakage level of the acoustic port is reduced.

In an embodiment, the housing may include a rear space (e.g., the rear space 114 of FIG. 2) of the diaphragm, and the vent hole may connect the front space to the rear space. In an embodiment, the vent hole may be a first vent hole, and the housing may include a second vent hole (e.g., the second vent hole 240 of FIG. 2) connecting the rear space to the outside.

The earpiece according to an embodiment may include an ear tip (e.g., the ear tip 190 of FIG. 1) coupled to the acoustic port.

In an embodiment, the processor may be configured to, using the sensor, determine whether an ear tip is coupled to the housing, in response to determining that the ear tip is coupled to the housing, control the degree of closure of the valve such that the leakage level of the acoustic port is reduced, and in response to determining that the ear tip is not coupled to the housing, control the degree of closure of the valve such that the leakage level of the acoustic port increases.

According to an embodiment, an earpiece that does not include an ear tip may include a housing, a speaker, a valve, a sensor, and a processor. The speaker may include a diaphragm and be disposed within the housing. The housing may include a front space of the diaphragm, an acoustic port connected to the front space to transmit acoustic by the speaker to an outside of the earpiece, and a vent hole connected to the front space. The valve may be configured to open or at least partially close the vent hole. The sensor may be disposed within the housing. The processor may be configured to determine, using the sensor, a leakage level of the acoustic port, and based on the determined leakage level, control a degree of closure of the valve such that the leakage level of the acoustic port increases.

According to an embodiment, an earphone (e.g., the electronic device 100 of FIG. 1) configured to be worn on a user's ear may include a housing (e.g., the housing 110 of FIG. 1) forming an outer surface of the earphone that is in contact with the user's ear, a driver (e.g., the speaker 120 of FIG. 1) including a diaphragm (e.g., the diaphragm 125 of FIG. 1), a first valve (e.g., the first valve 135 of FIG. 1), a second valve (e.g., the second valve 245 of FIG. 2), a microphone (e.g., the sensor 102 of FIG. 1), and a processor (e.g., the processor 1020 of FIG. 10). The housing may include a first space (e.g., the front space 112 of FIG. 1), a second space (e.g., the rear space 114 of FIG. 1) separated from the first space by the diaphragm, an acoustic port (e.g., the acoustic port 111 of FIG. 1) connected to the first space to transmit acoustic generated by the driver to an outside, a first vent hole (e.g., the first vent hole 130 of FIG. 1) formed on the outer surface and connected to the first space, a second vent hole (e.g., the second vent hole 240 of FIG. 1) formed on the outer surface and connected to the second space, and a third vent hole (e.g., the third vent hole 250 of FIG. 1) located inside the housing and connecting the first space and the second space. The first valve may be configured to regulate air flow in the first vent hole. The second valve may be configured to regulate air flow in the second vent hole. The microphone may be located within the first space. The processor may be configured to output acoustic through the driver. The processor may be configured to detect acoustic pressure in the first space using the microphone while the acoustic is outputted. The processor may be configured to, based on the acoustic pressure, determine a leakage level of the acoustic port. The processor may be configured to, based on the determined leakage level, control a degree of closure of the first valve and a degree of closure of the second valve, such that the leakage level of the acoustic port is reduced. Through this, it may reduce an influence due to leakage of the acoustic port, which may vary according to the user.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An earpiece comprising:
a housing;
a speaker including a diaphragm and disposed within the housing,
wherein the housing includes:
a front space of the diaphragm,
an acoustic port connected to the front space to transmit acoustic by the speaker to an outside of the earpiece, and
a vent hole connected to the front space;
a valve configured to open or at least partially close the vent hole;
a sensor disposed within the housing; and
a processor configured to:
determine, using the sensor, a leakage level of the acoustic port, and
based on the determined leakage level, control a degree of closure of the valve such that the leakage level of the acoustic port is reduced.

2. The earpiece of claim 1, wherein the sensor includes a microphone disposed within the front space of the housing.

3. The earpiece of claim 1, wherein the sensor is configured to detect acoustic impedance of the front space.

4. The earpiece of claim 1, wherein the vent hole connects the front space to the outside.

5. The earpiece of claim 4,
wherein the vent hole is a first vent hole;
wherein the housing includes:
a rear space of the diaphragm,
a second vent hole connecting the rear space to the outside, and
a third vent hole connecting the rear space to the front space;
wherein the valve is a first valve,
wherein the earpiece includes a second valve configured to open or at least partially close the second vent hole, and
wherein the processor is configured to control a degree of closure of the first valve and the second valve based on the determined leakage level, such that the leakage level of the acoustic port is reduced.

6. The earpiece of claim 5, wherein the processor is configured to close the first valve and the second valve in response to determining that the leakage level of the acoustic port is equal to or greater than a first threshold.

7. The earpiece of claim 6,
wherein the processor is configured to, in response to determining that the leakage level of the acoustic port is less than the first threshold and equal to or greater than a second threshold, close the first valve and open the second valve, and
wherein the second threshold is smaller than the first threshold.

8. The earpiece of claim 7,
wherein the processor is configured to, in response to determining that the leakage level of the acoustic port is less than the second threshold and equal to or greater than a third threshold, open the first valve and close the second valve, and
wherein the third threshold is smaller than the second threshold.

9. The earpiece of claim 8, wherein the processor is configured to, in response to determining that the leakage level of the acoustic port is less than the third threshold, open the first valve and the second valve.

10. The earpiece of claim 5,
wherein the housing includes:
a hole formed on an outer surface of the housing, and
a conduit connecting the rear space to the outside, and
wherein the second vent hole and the conduit are connected to the outside through the hole.

11. The earpiece of claim 5,
wherein the housing includes:
a hole formed on an outer surface of the housing, and
a conduit extending from the hole to the rear space, and
wherein the second vent hole is formed in the conduit.

12. The earpiece of claim 11, wherein the second vent hole is aligned with the hole.

13. The earpiece of claim 12, wherein the housing includes another conduit extending from the second vent hole to the rear space.

14. The earpiece of claim 5, comprising another microphone disposed within the rear space,
wherein the housing includes:
a hole formed on an outer surface of the housing, and
a conduit extending from the hole to the rear space, and
wherein the second vent hole is formed on the outer surface of the housing and is located farther from the another microphone than the hole.

15. The earpiece of claim 5, comprising a third valve configured to open or at least partially close the third vent hole, and
wherein the processor is configured to control the degree of closure of the first valve, the second valve, and the third valve based on the determined leakage level, such that the leakage level of the acoustic port is reduced.

16. The earpiece of claim 4,
wherein the vent hole is a first vent hole,
wherein the housing includes:
a rear space of the diaphragm,
a second vent hole connecting the rear space to the outside, and
a third vent hole connecting the rear space to the front space,
wherein the valve is a first valve,
wherein the earpiece includes a second valve configured to open or at least partially close the third vent hole, and
wherein the processor is configured to control the degree of closure of the first valve and the second valve based on the determined leakage level, such that the leakage level of the acoustic port is reduced.

17. The earpiece of claim 1,
wherein the housing includes a rear space of the diaphragm,
wherein the vent hole connects the front space to the rear space,
wherein the vent hole is a first vent hole, and
wherein the housing includes a second vent hole connecting the rear space to the outside.

18. The earpiece of claim 1, wherein the processor is configured to:
determine whether an ear tip is coupled to the housing;
in response to determining that the ear tip is coupled to the housing, control the degree of closure of the valve such that the leakage level of the acoustic port is reduced; and
in response to determining that the ear tip is not coupled to the housing, control the degree of closure of the valve such that the leakage level of the acoustic port increases.

19. An earpiece that does not include an ear tip, the earpiece comprising:
a housing;
a speaker including a diaphragm and disposed within the housing,
wherein the housing includes:
a front space of the diaphragm,
an acoustic port connected to the front space to transmit acoustic by the speaker to outside of the earpiece, and
a vent hole connected to the front space;
a valve configured to open or at least partially close the vent hole;
a sensor disposed within the housing; and
a processor configured to:
determine, using the sensor, a leakage level of the acoustic port, and
based on the determined leakage level, control a degree of closure of the valve such that the leakage level of the acoustic port increases.

20. An earphone configured to be worn on a user's ear, the earphone comprising:
a housing forming an outer surface of the earphone that is in contact with the user's ear;
a driver including a diaphragm,
wherein the housing includes:
a first space,
a second space separated from the first space by the diaphragm,
an acoustic port connected to the first space to transmit acoustic generated by the driver to an outside,
a first vent hole formed on the outer surface and connected to the first space,
a second vent hole formed on the outer surface and connected to the second space, and
a third vent hole located inside the housing and connecting the first space and the second space;
a first valve configured to regulate air flow in the first vent hole;
a second valve configured to regulate air flow in the second vent hole;
a microphone located within the first space; and
a processor configured to:
output acoustic through the driver,
detect acoustic pressure in the first space using the microphone while the acoustic is outputted,
based on the acoustic pressure, determine a leakage level of the acoustic port, and
based on the determined leakage level, control a degree of closure of the first valve and a degree of closure of the second valve, such that the leakage level of the acoustic port is reduced.
